(19) United States
(12) Patent Application Publication
(10) Pub. No.: US 2026/0185675 A1
(43) Pub. Date: Jul. 2, 2026

(54) DIMMING INDICATION MECHANISM AND VEHICLE LAMP

(71) Applicant: HASCO VISION TECHNOLOGY CO., LTD., Shanghai (CN)

(72) Inventors: Feiquan LI, Shanghai (CN); Yuan ZHANG, Shanghai (CN); Zhiping QIU, Shanghai (CN); Jie ZHANG, Shanghai (CN)

(21) Appl. No.: 19/131,421

(22) PCT Filed: Aug. 3, 2023
(86) PCT No.: PCT/CN2023/111018

§ 371 Date: May 20, 2025

(30) Foreign Application Priority Data
Feb. 16, 2023 (WO) PCT/CN2023/076434

(51) Int. Cl. F21S 41/657

(52) U.S. Cl. CPC F21S 41/657

(57) ABSTRACT

The vehicle lamp according to claim 19, A dimming indication mechanism and a vehicle lamp are provided. The dimming indication mechanism includes: a housing; and a sliding member, which is slidable on the housing in a first direction, wherein a driving assembly is further provided on the housing; the driving assembly is configured to be connected to an adjusting assembly of the vehicle lamp; a transmission assembly is further provided between the driving assembly and the sliding member, such that the sliding member is driven to move by means of the transmission assembly when the driving assembly drives the adjusting assembly to rotate; and an indicating member is provided on the housing in the first direction, and is configured to indicate the rotation angle of the driving assembly according to the positional relationship between the sliding member and the indicating member.

The present disclosure claims priority to International Application No. PCT/CN2023/076434, filed in China on Feb. 16, 2023, the entire contents of which are incorporated herein by reference.

### TECHNICAL FIELD

The present disclosure relates to the technical field of automobile lamps, and specifically to a dimming indication mechanism and a vehicle lamp.

### BACKGROUND ART

The vehicle lamp is an essential part of a vehicle. With economic development, users and manufacturers have increasingly higher requirements for the usage experience of the vehicle lamp. In order to ensure that the light output angle of the vehicle lamp after installation meets requirements of users, a reliable dimming function is particularly important. According to the design specification of vehicle lamps, the low beam of vehicle lamps should meet the ability to be adjusted in the horizontal and vertical directions, and the high beam should be at least adjusted in the vertical direction.

In the prior art, the dimming shaft of the vehicle lamp is usually composed of a ball-end nut and a ball-end screw. Through the rotation of the ball screw, the rotation is converted into translational motion by the thread screws, which drives the mirror or module to rotate around the dimming shaft, thereby achieving the adjustment of light. However, in the prior art, the dimming angle is not indicated, or a level can be mounted in the lamp to read the light adjustment position, so as to obtain the dimming angle. The method of built-in level has extremely high requirements for the vehicle posture during the dimming, and is difficult to perform precise dimming.

### SUMMARY

In response to the above deficiencies in the prior art, the objective of the present disclosure is to provide a dimming indication mechanism and a vehicle lamp, which can more accurately display the adjustment angle of the optical module and have no requirement for the vehicle posture.

In order to realize the above object, the technical solutions adopted in the embodiments of the present disclosure are as follows.

An aspect of embodiments of the present disclosure is to provide a dimming indication mechanism, including: a housing and a sliding member sliding on the housing in a first direction, wherein the housing is further provided with a driving assembly, and the driving assembly is configured to connect to an adjustment assembly of a vehicle lamp; a transmission assembly is further arranged between the driving assembly and the sliding member, so that the transmission assembly drives the sliding member to move when the driving assembly drives the adjustment assembly to rotate; and the housing is provided with an indicating member in the first direction, which is configured to indicate a rotation angle of the driving assembly according to a positional relationship between the sliding member and the indicating member.

Optionally, the driving assembly is connected to the transmission assembly by a gear assembly, so as to drive the transmission assembly to rotate when the driving assembly rotates.

Optionally, the gear assembly includes a first bevel gear arranged on the driving assembly and a second bevel gear arranged on the transmission assembly, wherein the first bevel gear is engaged with the second bevel gear.

Optionally, the transmission assembly further includes a screw connected to the second bevel gear; the sliding member is provided with a threaded hole corresponding to the screw; and the screw is connected to the threaded hole to drive the sliding member to move in the first direction when the screw rotates.

Optionally, the screw is provided with a plurality of weight reduction holes to reduce a weight of the screw.

Optionally, the housing is provided with a mounting groove, and the sliding member is mounted in the housing by the mounting groove, wherein the sliding member includes a sliding part slidably connected to two side walls of the housing and a transmission part connected to the transmission assembly, and the threaded hole is arranged in the transmission part.

Optionally, a pressing part is connected to an end part of the transmission part extending out of the housing; the sliding part is elastically connected to the transmission part; and a gap exists between the transmission part and the sliding part on two sides, so that the sliding member is mounted in the housing by pressing the pressing part.

Optionally, an inner side wall of the housing is provided with two groups of stopping ribs extending in the first direction, wherein the stopping ribs are located between the sliding part and the transmission part respectively, and two ends of the stopping ribs are connected to a side wall of the housing, so as to prevent the screw from continuing to rotate when the sliding member slides to an end part of the stopping ribs.

Optionally, one side of the transmission part away from the pressing part is provided with a mounting slideway communicated to the threaded hole, so that the screw enters the threaded hole by the mounting slideway when pressing the pressing part.

Optionally, the driving assembly includes an input member and an output member connected in a second direction by a driving method, wherein the input member is configured to connect to the driving source; the output member is configured to connect to the adjustment assembly; and the first bevel gear is arranged on the input member or the output member.

Optionally, the input member includes a driving part, the first bevel gear, and a first connecting part connected in sequence, and the output member includes a second connecting part, a mounting part, and an output part connected in sequence, wherein the first connecting part is connected to the second connecting part so that the input member is connected to the output member by a driving method; the driving part is configured to connect to a driving source; the mounting part is configured to connect the output member to the housing; and the output part is configured to connect to the adjustment assembly.

Optionally, the first connecting part is of a prism, and the second connecting part is a prismatic groove, wherein the prism extends into the prismatic groove, so that the input member drives the output member.

Optionally, an outer edge is arranged on a side surface of the housing away from the sliding member, and the outer edge is provided with a plurality of connecting holes for connecting the housing to the lamp body after extending into the connection member.

Another aspect of the embodiments of the present disclosure is to provide a vehicle lamp, including a lamp body and the above-mentioned dimming indication mechanism arranged on an outer side of the lamp body, wherein the lamp body includes an adjustment assembly, and a driving assembly of the dimming indication mechanism is connected to the adjustment assembly.

The present disclosure includes the following beneficial effects.

The present disclosure provides a dimming indication mechanism, including: a housing and a sliding member sliding on the housing in a first direction, wherein the housing is further provided with a driving assembly, and the driving assembly is configured to connect to an adjustment assembly of a vehicle lamp. The adjustment assembly is driven to rotate when the driving assembly rotates, and the position of the optical module is adjusted when the adjustment assembly rotates, so as to realize the adjustment for the optical module. A transmission assembly is further arranged between the driving assembly and the sliding member, so that the transmission assembly drives the sliding member to move when the driving assembly drives the adjustment assembly to rotate, and the adjustment assembly and the sliding member share a common drive, so that the rotation angle of the adjustment assembly, i.e., the adjustment angle of the optical module, can be deduced based on the movement distance of the sliding member. The housing is provided with the indicating member in the first direction, which is configured to indicate a rotation angle of the driving assembly according to the positional relationship between the sliding member and the indicating member. During the movement of the sliding member, the position of the sliding member and the indicating member changes relative to each other, wherein the movement distance of the sliding member can be determined according to the change in the position of the sliding member relative to the indicating member, so as to determine the rotation angle of the adjustment assembly. The embodiments of the present disclosure realize the display of the adjustment angle of the optical module by adopting a sliding member that moves simultaneously with the adjustment assembly, which realizes the display of the adjustment angle of the optical module without any requirement for the vehicle posture.

### BRIEF DESCRIPTION OF DRAWINGS

In order to more clearly illustrate the technical solutions in the embodiments of the present disclosure, the drawings to be used in the embodiments will be briefly introduced below. It should be understood that the following drawings only show certain embodiments of the present disclosure, and therefore should not be regarded as a limitation of the scope. For a person of ordinary skill in the art, other relevant drawings can be obtained according to these drawings without inventive efforts.

FIG. 1 shows a structure schematic diagram of a dimming indication mechanism provided by the embodiments of the present disclosure;

FIG. 2 shows an explosion diagram of a dimming indication mechanism provided by the embodiments of the present disclosure;

FIG. 3 shows another structure schematic diagram of a dimming indication mechanism provided by the embodiments of the present disclosure;

FIG. 4 shows a sectional view of FIG. 3 along A-A;

FIG. 5 shows a sectional view of FIG. 3 along B-B;

FIG. 6 shows a structure schematic diagram of a sliding member provided by the embodiments of the present disclosure;

FIG. 7 shows a structure schematic diagram of a housing provided by the embodiments of the present disclosure;

FIG. 8 shows a structure schematic diagram of a transmission assembly provided by the embodiments of the present disclosure;

FIG. 9 shows an explosion diagram of a driving assembly provided by the embodiments of the present disclosure;

FIG. 10 shows one structure schematic diagram of a vehicle lamp provided by the embodiments of the present disclosure; and

FIG. 11 shows another structure schematic diagram of a vehicle lamp provided by the embodiments of the present disclosure.

Reference numbers: 10—dimming indication mechanism; 11—housing; 111—mounting groove; 112—stopping rib; 113—outer edge; 114—connecting hole; 12—sliding member; 121—threaded hole; 122—sliding part; 123—transmission part; 124—pressing part; 126—mounting slideway; 13—driving assembly; 131—first bevel gear; 132—input member; 133—output member; 134—driving part; 135—first connecting part; 136—second connecting part; 137—mounting part; 138—output part; 14—transmission assembly; 141—second bevel gear; 142—screw; 143—weight reduction hole; 15—indicating member; and 20—lamp body.

### DETAILED DESCRIPTION OF EMBODIMENTS

In order to make the purpose, technical solutions, and advantages of the embodiments of the present disclosure clearer, the technical solutions in the embodiments of the present disclosure will be clearly and completely described below in conjunction with the drawings in the embodiments of the present disclosure. It is obvious that the embodiments described are partial embodiments of the present disclosure, and not all of the embodiments. The assembly in embodiments of the present disclosure generally described and shown in the drawings herein can be arranged and designed in various different configurations.

Therefore, the following detailed description of the embodiments of the present disclosure arranged in the drawings is not intended to limit the scope of the present disclosure for which protection is claimed, but only represents selected embodiments of the present disclosure. It is to be noted that various features in the embodiments of the present disclosure can be combined with each other without conflict, and the combined embodiments still remain within the scope of protection of the present disclosure.

In the description of the present disclosure, it should be noted that orientations or positional relationships indicated by terms, such as “middle”, “up”, “down”, “left”, and “right”, are the orientations or positional relationships based on the drawings, or the orientation or positional relationship that the product of the present disclosure is customarily placed in use, and therefore is not to be understood as a limitation of the present disclosure. Additionally, the terms “first”, “second”, and “third”, etc., are used only to distinguish descriptions, and are not to be understood as indicating or implying a relative importance.

In the description of the present disclosure, it should further be noted that unless other expressly specifications and limitations, the terms “arrange” and “communicate” are to be understood in a broad sense, e.g., it can be a direct connection, an indirect connection through an intermediate medium, or a communication inside two elements. For a person of ordinary skill in the art, the specific meaning of the above terms in the present disclosure can be understood according to specific situations.

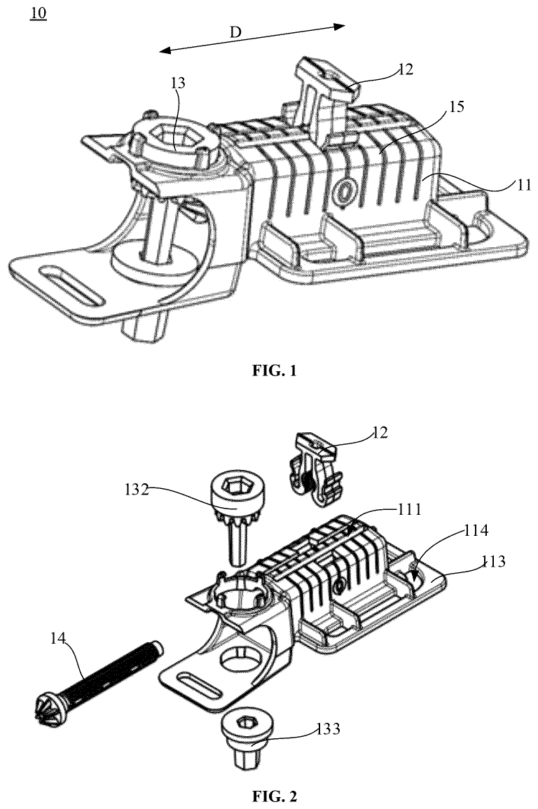

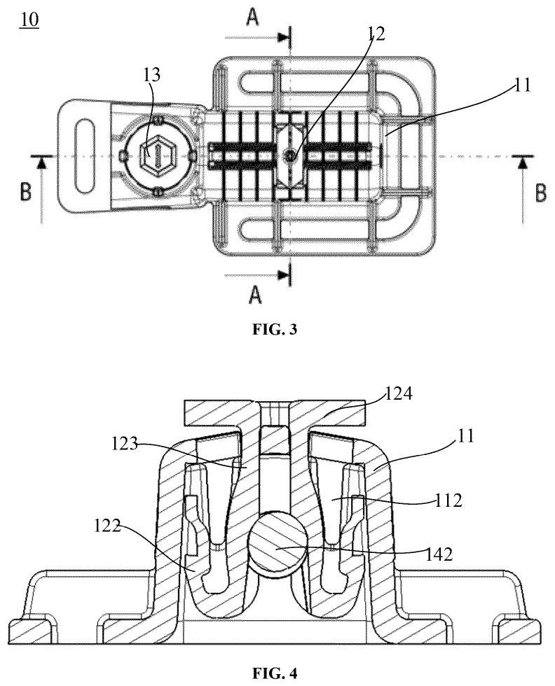

The embodiments of the present disclosure provide a dimming indication mechanism 10, as shown in FIG. 1 and FIG. 2, including: a housing 11 and a sliding member 12 sliding on the housing 11 in a first direction (the D direction in FIG. 1), wherein the housing 11 is further provided with a driving assembly 13, and the driving assembly 13 is configured to connect to an adjustment assembly of the vehicle lamp; a transmission assembly 14 is further arranged between the driving assembly 13 and the sliding member 12, so that the transmission assembly 14 drives the sliding member 12 to move when the driving member 13 drives the adjustment assembly to rotate; and the housing 11 is provided with an indicating member 15 in the first direction, which is configured to indicate a rotation angle of the driving assembly 13 according to a positional relationship between the sliding member 12 and the indicating member 15.

The dimming indication mechanism 10 provided by the embodiments of the present disclosure is applied to automobile lamps for indicating the specific angle adjusted by the optical module when adjusting the light output angle of the automobile lamps. Specifically, the dimming indication mechanism 10 of the embodiments of the present disclosure includes a driving assembly 13, a transmission assembly 14, and a sliding member 12, wherein one end of the driving assembly 13 is connected to the driving source, and the other end of the driving assembly 13 is connected to the adjustment assembly of the vehicle lamp. The driving assembly 13 is rotated under the driving of the driving source, so as to drive the adjustment assembly to rotate, and the adjustment assembly drives the lamp module to rotate, so as to adjust the light output angle of the vehicle lamp. Based on this, the driving assembly 13 is further connected to the sliding member 12 by the transmission assembly 14. When the driving assembly 13 is driven to rotate, the transmission assembly 14 drives the sliding member 12 to move in the first direction. Since the adjustment assembly and the sliding member 12 share a common driving source, the sliding member 12 rotates when the adjustment assembly rotates, i.e., the rotation angle of the sliding member 12 has a certain relationship to the movement distance of the sliding member. An indicating member 15 is further arranged on the housing 11 in the first direction. During the movement of the sliding member 12, the relative position of the sliding member 12 and the indicating member 15 changes, and the movement distance of the sliding member 12 can be obtained according to the relative positional relationship between the sliding member 12 and the indicating member 15. The rotation angle of the sliding member 12 has a certain relationship to the movement distance of the sliding member, so that the rotation angle of the adjustment assembly can be obtained, and the dimming indication mechanism 10 of the embodiments of the present disclosure can display the adjustment angle of the optical module. Additionally, the dimming structure of the present disclosure obtains the rotation angle of the driving member (i.e., the rotation angle of the adjustment assembly) according to the sliding distance of the sliding member 12, which is independent of the state of the vehicle, so that there is no requirement for the vehicle posture.

In order to more intuitively observe and obtain the adjustment state of the optical module, the indicating member 15 can be provided as an indication mark or an indication scale line. The indication mark or the indication scale line displays a specific value at a corresponding position, and the value of the adjustment angle can be directly read according to the corresponding relationship between the sliding member 12 and the indicating member 15.

It should be noted that the present disclosure has no limitations on the first direction. It can be along a straight line as shown in FIG. 1, or it can be along a clockwise or counterclockwise circumferential direction. Specifically, when the first direction is along the straight line as shown in FIG. 1, the movement of the driving assembly 13 is rotation and the movement of the sliding member 12 is the straight movement, at which time the driving assembly 13 is arranged on one end of the transmission assembly 14, and the transmission assembly 14 converts the rotation movement into the straight movement. When the first direction is along the clockwise or counterclockwise circumference movement, the movement of the driving assembly 13 is the rotation and the movement of the sliding member 12 is also the rotation, at which time the transmission assembly 14 will transmit the movement of rotation. The specific structures and connection method of the driving assembly 13 and the transmission assembly 14 are not limited by the embodiments of the present disclosure, and those skilled in the art can make specific arrangements according to the actual situation.

The present disclosure provides a dimming indication mechanism 10, including: a housing 11 and a sliding member 12 sliding on the housing 11 in the first direction, wherein the housing 11 is further provided with a driving assembly 13, and the driving assembly 13 is configured to connect to an adjustment assembly of the vehicle lamp. The adjustment assembly is driven to rotate when the driving assembly 13 rotates, and the position of the optical module is adjusted when the adjustment assembly rotates, so as to realize the adjustment for the optical module. A transmission assembly 14 is further arranged between the driving assembly 13 and the sliding member 12, so that the transmission assembly 14 drives the sliding member 12 to move when the driving assembly 13 drives the adjustment assembly to rotate, and the adjustment assembly and the sliding member share a common drive, so that the rotation angle of the adjustment assembly, i.e., the adjustment angle of the optical module, can be deduced based on the movement distance of the sliding member 12. The housing 11 is provided with the indicating member 15 in the first direction, which is configured to indicate a rotation angle of the driving assembly 13 according to the positional relationship between the sliding member 12 and the indicating member 15. During the movement of the sliding member 12, the position of the sliding member 12 and the indicating member 15 changes relative to each other, wherein the movement distance of the sliding member 12 can be determined according to the change in the position of the sliding member 12 relative to the indicating member 15, so as to determine the rotation angle of the adjustment assembly. The embodiments of the present disclosure realize the display of the adjustment angle of the optical module by adopting the sliding member 12 that moves simultaneously with the adjustment assembly, which realizes the display of the adjustment angle of the optical module without any requirement for the vehicle posture.

Optionally, as shown in FIG. 2 and FIG. 5, the driving assembly 13 is connected to the transmission assembly 14 by a gear assembly, so as to drive the transmission assembly 14 to rotate when the driving assembly rotates 13.

The movement mode of the driving assembly 13 is to rotate in the direction. The driving assembly 13 drives the adjustment assembly and the transmission assembly 14 simultaneously, so that the driving assembly 13 is connected to the transmission assembly 14 by the gear assembly, so as to transmit the rotation to the transmission assembly 14.

As an optional embodiment, the gear assembly includes a first bevel gear 131 arranged on the driving assembly 13 and a second bevel gear 141 arranged on the transmission assembly 14, wherein the first bevel gear 131 is engaged with the second bevel gear 141. Optionally, the transmission assembly 14 further includes a screw 142 connected to the second bevel gear 141, wherein the screw 142 extends in the first direction; the sliding member 12 is provided with a threaded hole 121 corresponding to the screw 142 in the first direction; and the screw 142 is connected to the threaded hole 121 to drive the sliding member 12 to move in the first direction when the screw 142 rotates.

When the first direction is the D direction as shown in FIG. 1, the sliding member 12 moves along a straight line, and the movement mode is the straight movement. At this time, the gear assembly needs to change the rotation mode of the driving assembly 13 to the straight movement mode of the connection member. The gear assembly includes the first bevel gear 131 on the driving assembly 13 and the second bevel gear 141 on the transmission assembly 14, wherein the planes where the rotation direction of the two bevel gears are located are mutually perpendicular to each other. By changing the rotation direction, the rotation direction of the transmission assembly 14 is perpendicular to the first direction.

Further, the transmission assembly 14 further includes a screw 142, the screw 142 is provided with thread screws, which can convert the rotation movement to the straight movement. Specifically, the transmission assembly 14 further includes the screw 142 connected to the second bevel gear 141, wherein when the second bevel gear 141 rotates, the screw 142 rotates along with it. The sliding member 12 is provided with the threaded hole 121 corresponding to the screw 142, and the screw 142 is connected to the threaded hole 121. When the screw 142 rotates along with the second bevel gear 141, the sliding member 12 is driven to move in the first direction.

The first direction is set as a straight line direction, which can save the space occupied by the dimming indication mechanism 10 in the width direction, and is convenient to be mounted in conjunction with the lamp body 20 of the vehicle lamp.

As an optional embodiment, the screw 142 is provided with a plurality of weight reduction holes 143 to reduce the weight of the screw 142.

As shown in FIG. 5 and FIG. 8, the screw 142 is provided with the plurality of weight reduction holes 143 to reduce the weight of the screw 142, so as to reduce resistance during rotation. Additionally, when the screw 142 is a plastic rod prepared by the injection molding process, the plurality of weight reduction holes 143 arranged on the screw 142 can further reduce the thickness of the screw 142, which avoids cracks or insufficient injection molding after the injection molding and cooling.

Furthermore, in order to reduce the weight of the dimming indication mechanism 10, each component of the dimming indication mechanism 10, including the driving assembly 13, the transmission assembly 14, and the sliding member 12, can be prepared by plastic.

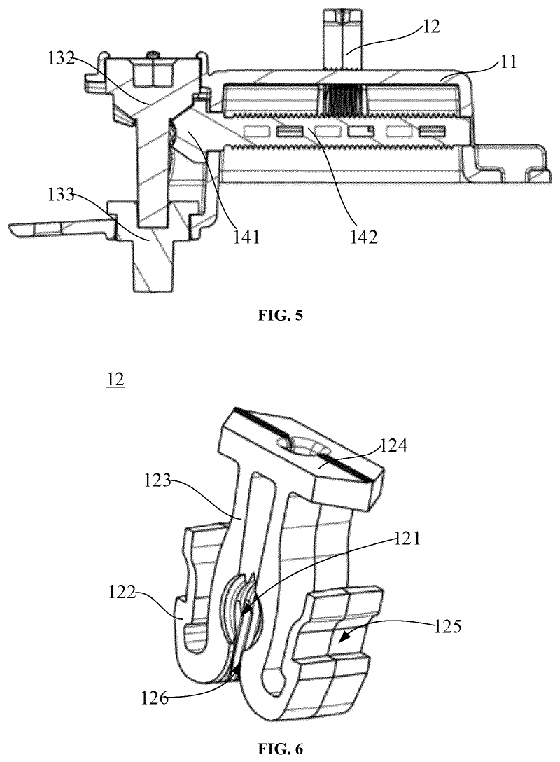

Optionally, as shown in FIG. 2 and FIG. 4, the housing 11 is provided with a mounting groove 111, and the sliding member 12 is mounted in the housing 11 by the mounting groove 111, wherein the sliding member 12 includes a sliding part 122 slidably connected to two side walls of the housing 11 and a transmission part 123 connected to the transmission assembly 14, and the threaded hole 121 is arranged in the transmission part 123.

The sliding member 12 is provided as the sliding part 122 and the transmission part 123, wherein the sliding part 122 is slidably connected to the two side walls of the housing 11 to realize the sliding. The threaded hole 121 is arranged in the transmission part 123, so that the transmission part 123 is connected to the screw 142 to realize the transmission.

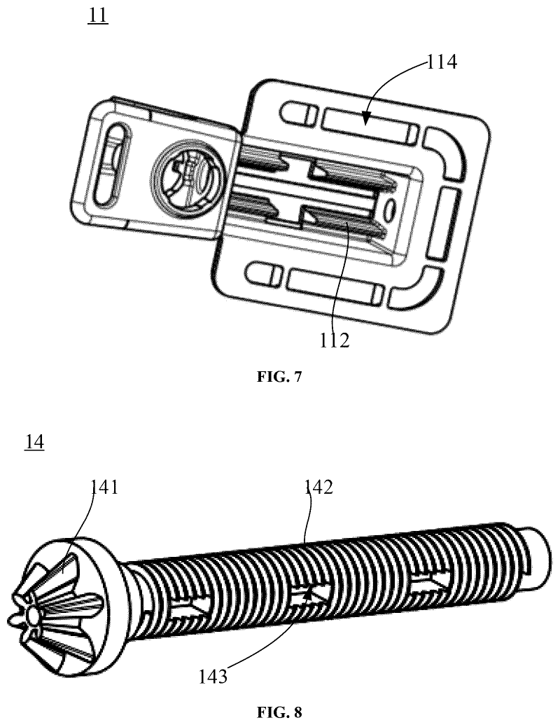

As an optional embodiment, as shown in FIG. 1, FIG. 2, FIG. 4, and FIG. 6, a pressing part 124 is connected to the end part of the transmission part 123 extending out of the housing 11; the sliding part 122 is elastically connected to the transmission part 123; and a gap exists between the transmission part 123 and the sliding part 122 on two sides, so that the sliding member 12 is mounted in the housing 11 by pressing the pressing part 124.

Specifically, the sliding part 122 is elastically connected to the transmission part 123, and the pressing part 124 is arranged on a part of the transmission part 123 extending out of the housing 11. When the sliding member 12 enters the housing 11, one side away from the pressing part 124 is faced the mounting groove 111 first and then pressed. Since the sliding part 122 is elastically connected to the transmission part 123, and it is extruded by the side wall of the mounting groove 111 at this time, the sliding part 122 is close towards the transmission part 123 and stores the elastic potential energy. By the mounting groove 111, the elastic potential energy is released, and the sliding part 122 opens outwardly when entirely enters into the housing 11, so as to contact with the side wall of the housing 11.

The sliding member 12 is mounted by the mounting groove 111, so that it does not need to preserve a mounting port on two sides of the housing 11, and the housing 11 is as a whole, so as to limit the sliding interval of the sliding member 12 on two ends; and mounting the sliding member 12 by the pressing method is convenient and quick.

As an optional embodiment, as shown in FIG. 4 and FIG. 7, an inner side wall of the housing 11 is provided with two groups of stopping ribs 112 extending in the first direction, wherein the stopping ribs 112 are located between the sliding part 122 and the transmission part 123 respectively, and two ends of the stopping ribs 112 are connected to the side wall of the housing 11, so as to prevent the screw 142 from continuing to rotate when the sliding member 12 slides to the end part of the stopping ribs 112.

Specifically, the sliding member 12 slides along the mounting groove 111. When the sliding member 12 slides to the side wall of the housing 11, the sliding member 12 cannot continue to move due to resisting of the side wall, at which time the screw 142 continues to rotate. Due to the elastic connection between the transmission part 123 and the sliding part 122, it is to extrude the transmission part 123 when the screw 142 rotates, so that the transmission part 123 expands outwardly, which in turn causes thread stripping between the thread screws on the screw 142 and the thread screws on the threaded hole 121, so as to damage the thread screws of the screw 142 and the threaded hole 121. In order to avoid the above situation, the inner side wall of the housing 11 in the embodiments of the present disclosure is provided with two groups of stopping ribs 112 extending in the first direction, wherein the two groups of stopping ribs 112 are respectively located between the transmission part 123 and the sliding part 122 on two sides. In this way, when the sliding member 12 slides to the side wall of the housing 11, the screw 142 continues to rotate. Due to the existence of the stopping ribs 112, the transmission part 123 cannot expand outwardly, and the screw 142 cannot continue to rotate, which avoids damages to the thread screws of the screw 142 and threaded hole 121. Additionally, when the screw 142 cannot continue to rotate, the driving assembly 13 cannot continue to rotate, which is equivalent to sending an inhibit signal.

Optionally, as shown in FIG. 4 and FIG. 6, one side of the transmission part 123 away from the pressing part 124 is provided with a mounting slideway 126 communicated to the threaded hole 121, so that the screw 142 enters the threaded hole 121 by the mounting slideway 126 when pressing the pressing part 124.

As can be seen from the above, during the process of mounting the sliding member 12, the sliding member 12 is pressed from top to bottom, so that the sliding member 12 partially enters the housing 11, and the screw 142 needs to enter the threaded hole 121. In order to facilitate the entry of the screw 142, one side of the transmission part 123 away from the pressing part 124 is provided with the mounting slideway 126 communicated to the threaded hole 121. When mounting the sliding member 12, the screw 142 enters the threaded hole 121 via the mounting slideway 126.

As an optional embodiment, as shown in FIG. 2, FIG. 5, and FIG. 9, the driving assembly 13 includes an input member 132 and an output member 133 connected in a second direction by a driving method, wherein the input member 132 is configured to connect to the driving source; the output member 133 is configured to connect to the adjustment assembly; and the first bevel gear 131 is arranged on the input member 132 or the output member 133.

The driving assembly 13 is provided as the input member 132 and the output member 133 connected in a driving method. In order to facilitate the mounting, the output member 133 can be mounted between two mounting holes first, and then the input member 132 is mounted from the other side of the housing 11, wherein the input member 132 is connected to the output member 133. Furthermore, after the damage of one of them, it only needs to replace only one of them, which avoids replacement of the whole component.

When the driving assembly 13 includes the input member 132 and the output member 133, the mounting holes are arranged on the housing 11 corresponding to the input member 132 and the output member 133 for snapping to the input member 132 and the output member 133 respectively.

Optionally, as shown in FIG. 9, the input member 132 includes the driving part 134, the first bevel gear 131, and the first connecting part 135 connected in sequence, and the output member 133 includes the second connecting part 136, the mounting part 137, and the output part 138 connected in sequence, wherein the first connecting part 135 is connected to the second connecting part 136 so that the input member 132 is connected to the output member 133 by a driving method; the driving part 134 is configured to connect to the driving source; the mounting part 137 is configured to connect the output member 133 to the housing 11; and the transmission part 123 is configured to connect to the adjustment assembly.

The driving part 134 is used to connect to the driving source. When the driving source is in a shape of an outer hexagon, the driving part 134 can be in a shape of an inner hexagon as shown in FIG. 9. The first bevel gear 131 is connected to the second bevel gear 141 to change the rotation direction; the first connecting part 135 is connected to the second connecting part 136, so that the input member 132 is connected to the output member 133 in a driving method; the mounting part 137 cooperates with the mounting holes on the housing 11 to realize the connection between the output member 133 and the housing 11; and the output part 138 is connected to the adjustment assembly. When the adjustment assembly is in a shape of the inner hexagon, the output part 138 is in a shape of the outer hexagon.

The above is only a specific embodiment of the present disclosure, and the person skilled in the art can make specific arrangements for the driving part 134, the first connecting part 135, the second connecting part 136, the mounting part 137, and the output part 138 according to the actual situation.

As an optional embodiment, as shown in FIG. 9, the first connecting part 135 is of a prism, and the second connecting part 136 is a prismatic groove, wherein the prism extends into the prismatic groove, so that the input member 132 drives the output member 133.

The input member 132 drives the output member 133 to rotate synchronously by using the prism and the prismatic groove, which provides a better synchronization.

The specific structures of the prism and the prismatic groove are not limited by the embodiments of the present disclosure. Exemplarily, it can be a hexagonal prism and a hexagonal hole as shown in FIG. 9, or it can be a triangular prism, or a quadrangular prism, etc. Those skilled in the art can make arrangements according to the actual situation.

Optionally, as shown in FIG. 2 and FIG. 7, an outer edge 113 is arranged on a side surface of the housing 11 away from the sliding member 12, and the outer edge 113 is provided with a plurality of connecting holes 114 for connecting the housing to the lamp body 20 after extending into the connection member.

In order to facilitate the connection between the dimming indication mechanism 10 and the lamp body 20, the outer edge 113 is arranged on the side surface of the housing 11 away from the sliding member 12, and the outer edge 113 is provided with the plurality of connecting holes 114. When the dimming indication mechanism 10 is connected to the lamp body 20, the connection member passes through the connecting holes 114 and is fixedly connected to the lamp body 20, so that the dimming indication mechanism 10 is fixedly connected to the lamp body 20, which facilitates the connection between the dimming indication mechanism 10 and the lamp body 20.

As shown in FIG. 7, the outer edge 113 and the housing 11 can be an integral structure to improve the fastness of the connection of the outer edge 113 to the housing 11.

Specifically, the mounting process of the dimming indication mechanism 10 of the embodiments of the present disclosure is as follows:
step 1: mounting the output member 133 to the corresponding mounting hole;
step 2: mounting the transmission assembly 14 into the hole of the screw 142 in the housing 11;
step 3: mounting the input member 132 to the corresponding mounting holes, wherein the first connecting part 135 is connected to the second connecting part 136, and the first bevel gear 131 is engaged with the second bevel gear 141; and
step 4: pressing the sliding member 12 into the housing 11, wherein the screw 142 enters the threaded hole 121 via the mounting slideway 126.

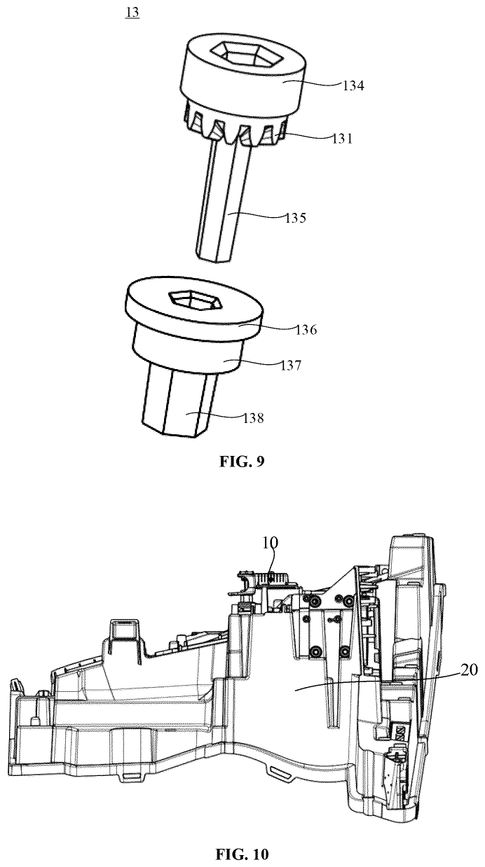

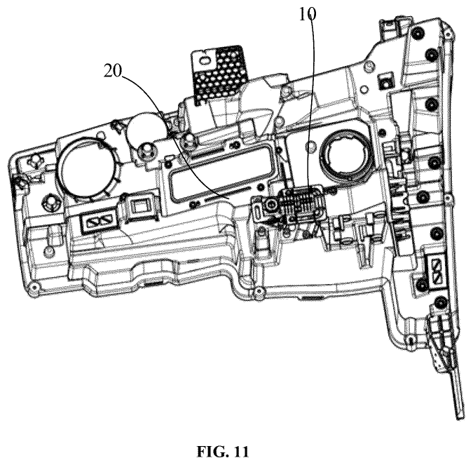

The embodiments of the present disclosure further disclose a vehicle lamp, as shown in FIG. 10 and FIG. 11, including the lamp body 20 and the above-mentioned dimming indication mechanism 10 arranged on an outer side of the lamp body 20, wherein the lamp body 20 includes the adjustment assembly, and the driving assembly 13 of the dimming indication mechanism 10 is connected to the adjustment assembly. The vehicle lamp has the same structure and beneficial effects as the dimming indication mechanism in the foregoing embodiment. The structure and the beneficial effects of the dimming indication mechanism have been described in detail in the foregoing embodiments and will not be repeated herein.

Specifically, the method of mounting the dimming indication mechanism 10 to the lamp body 20 is as follows:
step 1: mounting the dimming indication mechanism 10 to the lamp body 20; inserting the output part 138 of the output member 133 into the adjustment assembly of the lamp body 20, and connecting it to the lamp body 20 by using the connection member passing through the connecting hole 114;
step 2: performing dimming on the lamp body 20 before the vehicle lamp leaves the factory, at which time the sliding member 12 is not mounted into the housing 11 and will not rotate with the rotation of the screw 142;
step 3: pressing the sliding member 12 into the housing 11, so that the screw 142 enters the threaded hole 121 via the mounting slideway 126, at which point the sliding movements points to the initial position; and
step 4: mounting the vehicle lamp behind the vehicle body, at which time the sliding member 12 cooperates with the screw 142 when performing the dimming for the vehicle lamp, so as to record the dimming angle.

### Industrial Applicability

The present disclosure provides a dimming indication mechanism, wherein the adjustment assembly is driven to rotate when the driving assembly rotates, and the position of the optical module is adjusted when the adjustment assembly rotates, so as to realize the adjustment for the optical module. The transmission assembly drives the sliding member to move when the driving assembly drives the adjustment assembly to rotate, and the adjustment assembly and the sliding member share a common drive, so that the rotation angle of the adjustment assembly, i.e., the adjustment angle of the optical module, can be deduced based on the movement distance of the sliding member. During the movement of the sliding member, the position of the sliding member and the indicating member changes relative to each other, wherein the movement distance of the sliding member can be determined according to the change in the position of the sliding member relative to the indicating member, so as to determine the rotation angle of the adjustment assembly. The embodiments of the present disclosure realize the display of the adjustment angle of the optical module by adopting a sliding member that moves simultaneously with the adjustment assembly, which realizes the display of the adjustment angle of the optical module without any requirement for the vehicle posture.

1. A dimming indication mechanism, comprising a housing and a sliding member sliding on the housing in a first direction, wherein the housing is provided with a driving assembly, and the driving assembly is configured to connect to an adjustment assembly of a vehicle lamp; a transmission assembly is further arranged between the driving assembly and the sliding member, so that the transmission assembly drives the sliding member to move when the driving assembly drives the adjustment assembly to rotate; and the housing is provided with an indicating member in the first direction, wherein the indicating member is configured to indicate a rotation angle of the driving assembly according to a positional relationship between the sliding member and the indicating member.

2. The dimming indication mechanism according to claim 1, wherein the driving assembly is connected to the transmission assembly by a gear assembly, so as to drive the transmission assembly to rotate when the driving assembly rotates.

3. The dimming indication mechanism according to claim 2, wherein the gear assembly comprises a first bevel gear arranged on the driving assembly and a second bevel gear arranged on the transmission assembly, and the first bevel gear is engaged with the second bevel gear.

4. The dimming indication mechanism according to claim 3, wherein the transmission assembly further comprises a screw connected to the second bevel gear; the sliding member is provided with a threaded hole corresponding to the screw; and the screw is connected to the threaded hole to drive the sliding member to move in the first direction when the screw rotates.

5. The dimming indication mechanism according to claim 4, wherein the screw is provided with a plurality of weight reduction holes to reduce a weight of the screw.

6. The dimming indication mechanism according to claim 4, wherein the housing is provided with a mounting groove, and the sliding member is mounted in the housing by the mounting groove, wherein the sliding member comprises a sliding part slidably connected to two side walls of the housing and a transmission part connected to the transmission assembly, and the threaded hole is arranged in the transmission part.

7. The dimming indication mechanism according to claim 6, wherein a pressing part is connected to an end part of the transmission part extending out of the housing; the sliding part is elastically connected to the transmission part; and a gap exists between the transmission part and the sliding part on two sides, so that the sliding member is mounted in the mounting groove by pressing the pressing part.

8. The dimming indication mechanism according to claim 7, wherein an inner side wall of the housing is provided with two groups of stopping ribs extending in the first direction, wherein the stopping ribs are located between the sliding part and the transmission part respectively, and two ends of the stopping ribs are connected to a side wall of the housing, so as to prevent the screw from continuing to rotate when the sliding member slides to an end part of the stopping ribs.

9. The dimming indication mechanism according to claim 7, wherein one side of the transmission part away from the pressing part is provided with a mounting slideway communicated to the threaded hole, so that the screw enters the threaded hole by the mounting slideway when pressing the pressing part.

10. The dimming indication mechanism according to claim 3, wherein the driving assembly comprises an input member and an output member connected in a second direction by a driving method, wherein the input member is configured to connect to a driving source; the output member is configured to connect to the adjustment assembly; and the first bevel gear is arranged on the input member or the output member.

11. The dimming indication mechanism according to claim 10, wherein the input member comprises a driving part, the first bevel gear, and a first connecting part connected in sequence, and the output member comprises a second connecting part, a mounting part, and an output part connected in sequence, wherein the first connecting part is connected to the second connecting part so that the input member is connected to the output member by a driving method; the driving part is configured to connect to the driving source; the mounting part is configured to connect the output member to the housing; and the output part is configured to connect to the adjustment assembly.

12. The dimming indication mechanism according to claim 11, wherein the first connecting part is of a prism, and the second connecting part is a prismatic groove, wherein the prism extends into the prismatic groove, so that the input member drives the output member.

13. The dimming indication mechanism according to claim 1, wherein an outer edge is arranged on a side surface of the housing away from the sliding member, and the outer edge is provided with a plurality of connecting holes for connecting the housing to a lamp body after extending into a connection member.

14. A vehicle lamp, comprising a lamp body and the dimming indication mechanism according to claim 1 arranged on an outer side of the lamp body, wherein the lamp body comprises the adjustment assembly, and the driving assembly of the dimming indication mechanism is connected to the adjustment assembly.

15. The vehicle lamp according to claim 14, wherein the driving assembly is connected to the transmission assembly by a gear assembly, so as to drive the transmission assembly to rotate when the driving assembly rotates.

16. The vehicle lamp according to claim 15, wherein the gear assembly comprises a first bevel gear arranged on the driving assembly and a second bevel gear arranged on the transmission assembly, and the first bevel gear is engaged with the second bevel gear.

17. The vehicle lamp according to claim 16, wherein the transmission assembly further comprises a screw connected to the second bevel gear; the sliding member is provided with a threaded hole corresponding to the screw; and the screw is connected to the threaded hole to drive the sliding member to move in the first direction when the screw rotates.

18. The vehicle lamp according to claim 17, wherein the screw is provided with a plurality of weight reduction holes to reduce a weight of the screw.

19. The vehicle lamp according to claim 17, wherein the housing is provided with a mounting groove, and the sliding member is mounted in the housing by the mounting groove, wherein the sliding member comprises a sliding part slidably connected to two side walls of the housing and a transmission part connected to the transmission assembly, and the threaded hole is arranged in the transmission part.

20. The vehicle lamp according to claim 19, wherein a pressing part is connected to an end part of the transmission part extending out of the housing; the sliding part is elastically connected to the transmission part; and a gap exists between the transmission part and the sliding part on two sides, so that the sliding member is mounted in the mounting groove by pressing the pressing part.
